(19) United States
(12) Patent Application Publication
(10) Pub. No.: US 2014/0076687 A1
(43) Pub. Date: Mar. 20, 2014

(54) PRODUCTION PLANT FOR BULK GOODS

(71) Applicants: Guy Petignat, Erlenbach ZH (CH); Jorge Chacon, Mesa, AZ (US)

(72) Inventors: Guy Petignat, Erlenbach ZH (CH); Jorge Chacon, Mesa, AZ (US)

(73) Assignee: ROWEG HOLDING AG, Erlenbach ZH (CH)

(21) Appl. No.: 14/110,948

(22) PCT Filed: Apr. 2, 2012
(86) PCT No.: PCT/CH2012/000076

§ 371 Date: Dec. 2, 2013

(30) Foreign Application Priority Data
Apr. 12, 2011 (CH) 648/11

(51) Int. Cl. B65G 49/00

(52) U.S. Cl. CPC B65G 49/00
USPC 198/341.09

(57) ABSTRACT

The production plant for bulk goods essentially includes a feed side for raw material, a processing unit for the material and a removal side for the processed products. In plants with a high output, the individual units of the plant run at a very high speed, causing wear and, as a result, disruptions to the process. It is therefore the object to step down the plant units running at a particularly high speed without thereby reducing the output. In the illustrative case of a plant for producing cotton sticks, this object is achieved by reducing the speed on the primary side and increasing the loading. When the speed of the primary chain is halved and the loading of blanks and wads is doubled, the same output is achieved with a significantly more moderate speed.

### BACKGROUND OF THE INVENTION

1. Field of the Invention

The invention is in the area of machine construction and relates to a production plant for producing bulk goods, in particular for producing cotton sticks.

2. Description of Related Art

Production plants for producing bulk goods are exposed to very rough operating conditions. Owing to commercial cost pressures, they run at the maximum output limit, generally round the clock. A plant which has just been put into operation and is well-adjusted runs satisfactorily. Due to intensive use and the harsh operating conditions, the plant suffers wear and faults occur in operation. The plant then has to be shut down and readjusted. Owing to the increasing wear, faults become more frequent and maintenance intervals become shorter, leading increasingly to production outages. In an early phase of a new plant, outages are within an economically acceptable range. However, outage rates increase progressively to double-digit percentages. With a plant that is still relatively usable, production outages of up to 30% have to be accepted in this case. This is not least labor-intensive. As time progresses, however, this is a matter not just of readjustment but also the replacement of parts, leading to longer stoppage times than for readjustment. Generally, the faults result from wear on machine parts, rather than from direct failure.

Wear occurs progressively and the plant begins to operate in an imprecise manner; in general, correction requires a time-consuming adjustment procedure. This is okay until such adjustments no longer work and machine parts have to be replaced. However, this is not a long-term solution either since all moving parts are subject to wear and they wear out one after the other. After a certain time in operation of the plant, there is the risk of continuous readjustment, removal, readjustment etc. until the plant as a whole has to be replaced.

The aim of maximum economy in production is to minimize fault events and the associated production outage and cost of labor. The service life of such plants must likewise be increased, and the reliability of the process within the plant must be improved by appropriate measures. In very general terms, maximum production must be enabled with the investment made in the plant. “Production numbers per period of operation” may be taken as a measure of this, for example.

The main problem is the susceptibility to faults of a machine which is, as it were, being operated continuously at the limit of the possible maximum rate. The example of the abovementioned plant for producing cotton sticks shows that it is operated at a rate of up to 162,000 sticks per hour, 2,700 sticks per minute (162,000/3,600) or 45 sticks per second, round the clock, seven days per week.

One of the problems with this plant is the wear on the primary carrier chain. As already explained above, the process reliability of the machine depends on this primary chain; with increasing wear, reliability decreases. The primary carrier chain consists of a circulating chain, also referred to as a conveyor or transport chain, with carriers attached thereto for receiving the individually fed sticks, these being provided during the process with cotton, also called absorbent cotton, at the ends thereof and being discharged from the carrier again. The primary carrier chain is subjected to very high stresses, stress due to the weight to be carried, stress due to stretching, stress due to vibration, stress due to friction and stress due to general deformation forces.

### BRIEF SUMMARY OF THE INVENTION

It is therefore the object of the present invention to propose a production plant for producing bulk goods, in particular cotton sticks, which has a long life, exhibits little wear and, in particular, is not very susceptible to faults. Thus, one of the aims is, in particular, to reduce the stress on the primary carrier chain while keeping the production capacity the same and therefore to subject it to less wear.

The object is achieved by the features of independent claim 1. Preferred developments and embodiments are described in the dependent claims.

The production plant contains a feed side for the raw material, a processing unit for said material and, preferably, a removal side for the products produced from the raw material.

The production plant is characterized in that it comprises means on the feed side for selectively multiplying the infeed of raw material. In simple terms, multiplying means that there is more raw material in terms of numbers or weight in each segment of the length of the feed section as the raw material is fed to the processing unit.

Given a corresponding reduction in the feed speed of the feed side in relation to the removal speed of the processed products, the feed rate or removal rate is thereby increased or reduced.

While the output of products on the feed side is kept the same, for example, the transport speed is thereby reduced. The output of products means, in particular, the number of products transferred to the removal side per unit time. Disruptions during processing and wear to the production plant are thereby reduced, and the process is easier to manage.

The feed side, also referred to as the feed device, preferably contains a primary carrier chain for feeding in a first raw material, in particular empty sticks. The feed speed of the first raw material relates to the speed of the primary carrier chain. The primary carrier chain is preferably of circulating design.

The production plant or the feed side furthermore preferably contains an apparatus in the form of a feed unit for feeding in a second raw material, in particular a cotton sliver or cotton strand. The feed speed of the second raw material thus relates to the speed at which the cotton sliver or cotton strand is fed to the feed side.

The feed unit is designed to transfer portions of cotton, also called absorbent cotton, from the cotton strand fed to the feed unit to the sticks, in particular to the ends thereof, carried along on the carriers along the delivery path of the primary carrier chain. For this purpose, the feed unit preferably also contains means, such as tear-off or scoring rollers, for dividing the cotton into portions. For this reason, said feed unit is also referred to as a metering unit.

The portions of cotton are taken up by the ends of the sticks, which are fed past the feed unit at a certain speed, and may be torn off from the cotton strand completely.

On the feed side, the production plant also contains a processing unit for producing products, in particular cotton sticks, by processing the raw material fed in, in particular the first and second raw material fed in.

According to a development of the invention, the processing unit of the production plants comprises means by means of which the second raw material dispensed onto the ends of the sticks by the feed unit is shaped thereon.

The production plant furthermore preferably also contains a removal side, also referred to as a removal device, preferably having a secondary carrier chain for removing the products. The speed of removal of the products relates, in particular, to the speed of the secondary carrier chain.

For this purpose, the production plant preferably contains a transfer unit, by means of which the products, in particular the cotton sticks, are transferred from the carriers of the primary carrier chain to carriers of the secondary carrier chain. The components of the transfer unit are preferably part of the feed and removal sides.

On the feed side, the production plant then comprises means for selectively multiplying the infeed of the raw material, in particular of the first and/or second raw material.

While correspondingly reducing the feed speed on the feed side in relation to the removal speed of the processed products, the feed rate or removal rate is thereby increased or reduced. If the output of products on the feed side is kept the same, for example, the transport speed is thereby reduced. Disruptions during processing and wear to the production plant are thereby reduced. Thus, the production process is easier to manage.

Multiplication of the infeed of the first raw material on the feed side can, for example, be achieved by reducing the spacing of the first raw material, which is in the form of blanks, in particular sticks, and is fed in by a carrier chain of the processing unit. During this process, the blanks are held on carriers, which, in turn, are attached to the carrier chain.

The spacing between the blanks can be reduced, for example, by providing a plurality of receptacles per carrier, in particular two receptacles, for receiving a plurality of blanks, in particular two blanks, instead of the previously customary single receptacle.

According to an alternative embodiment, the length of the carriers in the direction of circulation of the carrier chain can also be reduced, in particular halved. Thus, for example, as before the carrier can comprise just a single receptacle for a blank. However, by reducing the carrier length, the number of blanks per segment of the length of the carrier chain is nevertheless increased, e.g. doubled.

Thus, to increase the feed rate or the removal rate while keeping the speed of the chain the same or to maintain the feed rate or removal rate while reducing the speed of the chain, it is possible to provide blank carriers on which the holding distance between the blanks is shortened by half from a standard dimension of, for example, two inches to, for example, one inch. This means that there is space for twice the number of blanks per segment of the length of the chain.

By reducing the holding distances for the blanks on or between the carriers, the feed rate of the blanks to the processing unit and, correspondingly, also the output rate of the products following processing of the raw materials can be maintained for a reduced feed speed of the blanks or of the carrier chain.

In a preferred development of the invention, the production plant contains at least one first apparatus, also referred to as a feed module, on the feed side for feeding the first raw material, i.e. the blanks or sticks, to the carriers of the carrier chain. The apparatus can, for example, contain a storage cassette which receives the blanks and releases them to the carriers of the carrier chain in a cyclically controlled manner.

The production plant according to this development furthermore preferably contains at least one second apparatus, also referred to as a feed module or feed unit, on the feed side for feeding in a second raw material, in particular a cotton strand. The second apparatus corresponds, for example, to the feed unit already mentioned above for the cotton strand. The second raw material is preferably fed to the processing unit. The processing unit is expediently arranged along the carrier chain by means of which the first raw material is fed to the processing unit.

In order to reduce the feed rate of the first raw material, i.e. the blanks, to the carriers and/or of the second raw material, i.e. the cotton strand, to the processing unit, it is then also possible to provide a plurality of first and/or a plurality of second apparatuses, which feed the raw materials to the feed side in alternation, for example. Thus, the first apparatuses can load the carriers alternately with blanks. Thus, it is furthermore possible for the second apparatuses to feed the processing units alternately with the cotton strand. For this purpose, the first and/or second apparatuses can each be arranged one behind the other along the carrier chain, for example.

Accordingly, the plurality of first and/or second apparatuses can be switched selectively, in particular for alternately loading the carriers with sticks. Thus, the plurality of first and/or second apparatuses can load the carriers fully or partially in each case.

Another special aspect of the apparatus and also the method explained below is that a wear-optimized production speed can be set by reducing the mass, i.e. weight, of the feed per blank. Reducing the mass of the feed per blank means, in particular, reducing the moving weight of the feed, in particular of the primary carrier chain including the carriers, per blank.

The reduction in mass is achieved by making the carriers of lightweight construction. As mentioned, an improvement would namely result in a reduction in the weight of the carriers, which are currently produced from metal. This could be accomplished, for example, by making such carriers of a tough plastic or of some other light and wear resistant material, such as aluminum.

Thus, the carriers can be made of metal, in particular a ferrous metal, such as steel, or aluminum, for example. However, the carriers are preferably made from a plastic, such as polypropylene. However, the plastic preferably has a high impact strength. As a particularly preferred option, the plastic is fiber reinforced, in particular glass fiber reinforced.

Using carriers made of plastic has the advantage that the weight of the primary carrier chain can be greatly reduced. It is thereby also possible to save on driving energy. Moreover, the primary carrier chain of reduced weight can be accelerated and braked more effectively, and there is also a significant reduction in wear at the same time. Moreover, such a primary carrier chain operates with considerably less noise since less metal-on-metal noise is generated.

Alternatively or in addition to the preceding measure, the reduction in mass can also be achieved if, as already described above, the carrier chain takes along more blanks per segment of length while having the same chain length. It would namely likewise be possible to arrange receiving locations for a plurality of sticks on the same length of the carrier, and this would likewise result in a reduction in weight per stick.

As a further simple measure, the length of the carriers could also be halved, with the result that two sticks are transported on the same segment of the length of the chain instead of one.

By this means, it is ensured that the same production output (here 162,000 cotton sticks per hour) is achieved at half the chain speed. In this way, the weight of carrier per stick transported can be reduced, ensuring significantly less wear and hence a lower susceptibility to faults for the same capacity of the circulating primary carrier chain.

Halving the speed of the primary carrier chain but doubling the number of sticks is not enough to ensure a reduction in faults in the “cotton feed” unit of the plant in all respects because the virtual speed of passage of the individual sticks has remained the same. However, the dwell time of a stick under the cotton is then twice as long in comparison with the wear-inducing maximum speed and therefore, here too, a reduction in faults is achieved.

Another problem with the susceptibility to faults of this type of plant is the feeding in of cotton at high speed. In each case, appropriate portions of a cotton strand are plucked off for one side of the stick, stuck on the rotating stick and rolled up. Cotton is a natural product, which is subject to fluctuations in terms of its properties. The relevant processing parameter is thus also subject to fluctuations; it is, as it were, diffuse and cannot be correctly delimited and thus adjusted in an optimum manner. There is a “speed limit” and a “limiting distance” between the sticks for the feeding in of the cotton portions, and these cannot be overshot or undershot. These limits are below the capacity of the primary carrier chain, even in the case of reduced wear. It is best to define a speed range for the feeding in of the cotton and a speed range for reducing the wear on the primary carrier chain and to seek a range of overlap which can be applied to both and hence minimizes the susceptibility of both plant units to faults.

Another aspect of the invention therefore relates, inter alia, also to the reduction of the speed at which the cotton strand or cotton sliver is fed in while simultaneously maintaining the feed rate.

This is because the cotton strand tends to tear during the production process. This is because the cotton strand has a low strength. This is because the cotton strand contains a multiplicity of fibers running more or less parallel to one another with little adhesion between them. In particular, the cotton strand has no twist or virtually no twist, which would increase breaking strength. A cotton strand of this kind furthermore generally consists of a low-cost fiber material containing relatively short fibers, which is likewise detrimental to breaking strength.

Another reason for the low breaking strength of the cotton strand are the thin points (weak zones) in the cotton strand caused by irregularities, as explained further below.

On the one hand, this problem can be counteracted by increasing the weight of the cotton strand per unit of length, e.g. from 1.4 g/m (weight per unit of length) to 2.8 g/m. In this way, it is possible to feed in the same mass at half the speed. On the other hand, the number of cotton strands fed in can be doubled or multiplied from the current 2 to 4, 6 and 8 etc. In the case where the cotton strands are doubled, one pair of cotton strands feeds the cotton only to every second stick. By means of this measure, the speed of the cotton strand is likewise halved.

However, increasing the strand weight has the disadvantage that a cotton strand with a very particular strand weight has to be made available. However, the ideal weight for cotton strands does not correspond to a common sliver weight of the kind found with cotton slivers for other commercial applications.

In general, cotton strands are produced from conventional card slivers, which are produced in a carder. The carding engine is a tried and tested apparatus of the kind that has been used for a very long time in the processing of fiber material in the textile industry, for example. By means of the carder, an initial parallel alignment of the loose fibers of cleaned fiber flock to give a wide sliver, also referred to as a batt or web, takes place. The wide sliver is, for example, shaped in a funnel to give a round sliver, the card sliver, and deposited in a can in coils, for example.

The card sliver generally has a sliver weight of 5 to 20 g/m (grams per meter), in particular of around 8 g/m. However, the sliver weight is considerably too high for use in the production of cotton sticks. Ideally, the sliver or strand weight of the cotton strand fed to the feed unit is around 1.4 g/m.

For this reason, the wide card sliver has hitherto been divided in the longitudinal direction into smaller slivers, also referred to as cotton strands, of correspondingly lower sliver weight. This division is accomplished by means of a targeted flow of air, for example.

However, this method has the disadvantage that, owing to the process, the card sliver, which is per se uniform, cannot be divided into smaller slivers that are equally uniform. On the contrary, the smaller slivers produced from the uniform card sliver have thick and thin areas. On the one hand, this has the effect that dividing the cotton into uniform portions is difficult and, furthermore, that the cotton strand tends to tear in the thinner areas as it is fed to the feed unit.

Since the commercially available carders are designed for the production of card slivers with a sliver weight of 5 to 20 g/m, converting a carding machine to card slivers of a significantly lower sliver weight is virtually impossible. Moreover, a carding machine of this kind is used to produce card slivers for a very wide variety of uses. However, using cotton slivers to produce cotton sticks happens to be one of the few applications in which a very low sliver weight is taken as a starting point.

It is therefore the object to propose means by which a card sliver of correspondingly high sliver weight produced in a conventional carder can be used in a production plant according to the invention to produce cotton sticks.

This object is achieved by virtue of the fact that the production plant contains a drafting system, in which a sliver fed in is subjected to a draft while reducing the sliver weight. Drafting means pulling apart the fibers of a sliver to form a finer sliver.

The drafting system is preferably arranged ahead of the feed unit for the cotton strand in the process direction. The drafting system is preferably integrated into the production plant in such a way that, during the production of the cotton sticks, it produces a sliver with a draft which is fed uninterruptedly to the feed unit.

If the drafting system is operated at a higher output than the feed unit for further processing requires, an intermediate reservoir can be provided between the feed unit and the drafting system, in which reservoir the excess cotton strand is deposited and stored temporarily. However, it is advantageous if the cotton strand remains continuous during this process, i.e. is not divided.

The drafting system is preferably a roller drafting system having at least two rotating roller pairs spaced apart from one another in the delivery direction and rotating at different peripheral speeds. The two roller pairs form nip lines for the sliver, at which the sliver is in each case held with a nipping action. The second roller pair, which is situated downstream of the first roller pair in the process direction, runs at a higher peripheral speed.

The distance between the nip lines of the roller pairs in the process direction is then set in accordance with the sliver length. It is expedient if the nip line is set wider than the longest fiber of the drafted sliver. This distance between the roller pairs then defines the drafting zone in which the sliver is drafted. While most of the fiber material is held fast by the first, slower roller pair, some of the fibers pass between the faster rollers of the second roller pair. These push them forward, resulting in thinning of the sliver.

The bottom rollers can be metal cylinders. The top roller can have a flexible covering. It is expedient if the bottom rollers are actively driven while the top rollers are driven indirectly by the bottom rollers.

The drafting system furthermore preferably also contains a loading device, by means of which the top rollers can be loaded toward the bottom rollers.

The drafting system can now contain more than two roller pairs one behind the other in the delivery direction, defining more than one drafting zone. In this case, the following roller pair in each case always runs at a higher peripheral speed than the preceding roller pair. Thus, for example, three roller pairs arranged in series can define two drafting zones. A partial draft takes place in each of the drafting zones, and the partial drafts add up to a total draft across the drafting system.

The drafting system rollers can be driven by means of a separate driving device. In this case, the drive must be synchronized by means of control with the drive of the other moving parts of the plant, such as the carrier chain, or moving parts, in particular rotating parts, of the feed unit for the cotton etc.

The drafting system rollers are now preferably driven by means of a central drive, which, for example, also drives the carrier chain and the moving parts, in particular rotating parts, of the feed unit for the cotton. Here, the speeds of the drafting rollers are preferably synchronized with the speed of other moving parts of the plant by means of a mechanical transmission.

The invention furthermore also relates to a method for operating a production plant of the kind described above. The method is distinguished by the fact that the infeed of raw material is multiplied. The plants can then be operated in such a way that the raw material is fed in to the processing unit at a reduced feed rate on the feed side in relation to the removal speed of the products to give a constant output of products on the feed side.

According to a particular aspect of the invention, a development of the method is distinguished by the following steps:
feeding in a cotton sliver, in particular from a reservoir, to the drafting system of the production plant;
creating a draft in the cotton sliver by pulling the fibers in the cotton sliver apart, reducing the sliver weight;
feeding the drafted cotton sliver to the feed unit of the production plant; and
dividing up the fed and drafted cotton sliver and loading the sticks with cotton.

The cotton sliver passed into the drafting system can have a weight of 5 to 8 g/m, for example. The cotton strand released from the drafting system has a weight of 1.4 to 1.5 g/m, for example.

The total draft ratio can be 3:1 to 6:1, depending on the sliver weight of the cotton starting sliver. The draft ratio (drafting ratio) can be 1:1 (no draft) or 1.15:1 (very small draft) to 2:1, in particular 1:1 or 1.15:1 to 1.5:1 in the preliminary drafting zone (step 1), for example. In the main drafting zone (step 2), the draft ratio can be 3:1 to 4:1, for example.

### BRIEF DESCRIPTION OF THE DRAWINGS

An illustrative plant for producing cotton sticks will now be discussed in detail with the aid of the figures presented below, in which:

FIG. 1 is a perspective view of the primary conveying unit (feed side), the transfer point and the secondary conveying unit (removal side) of a plant for producing cotton sticks as an example of a production plant for bulk goods;

FIGS. 1A, 1B, and 1C are perspective views of various details of the plant shown in FIG. 1;

FIG. 2 is a perspective view of the primary conveying unit 10 from FIG. 1 in greater detail;

FIG. 2A is a partial exploded perspective view of the plant shown in FIG. 2;

FIG. 2B is a detailed partial perspective view of FIG. 2;

FIGS. 3-6 are perspective views of carriers of various designs for receiving sticks for the production of cotton sticks;

FIG. 7 is a perspective view of a roller drafting system for the cotton sliver in a production plant according to the invention;

FIG. 8 is a plan view of the roller drafting system according to FIG. 7; and

FIG. 9 is a cross-sectional elevation view along the line A-A through the roller drafting system shown in FIG. 8.

### DETAILED DESCRIPTION OF THE INVENTION

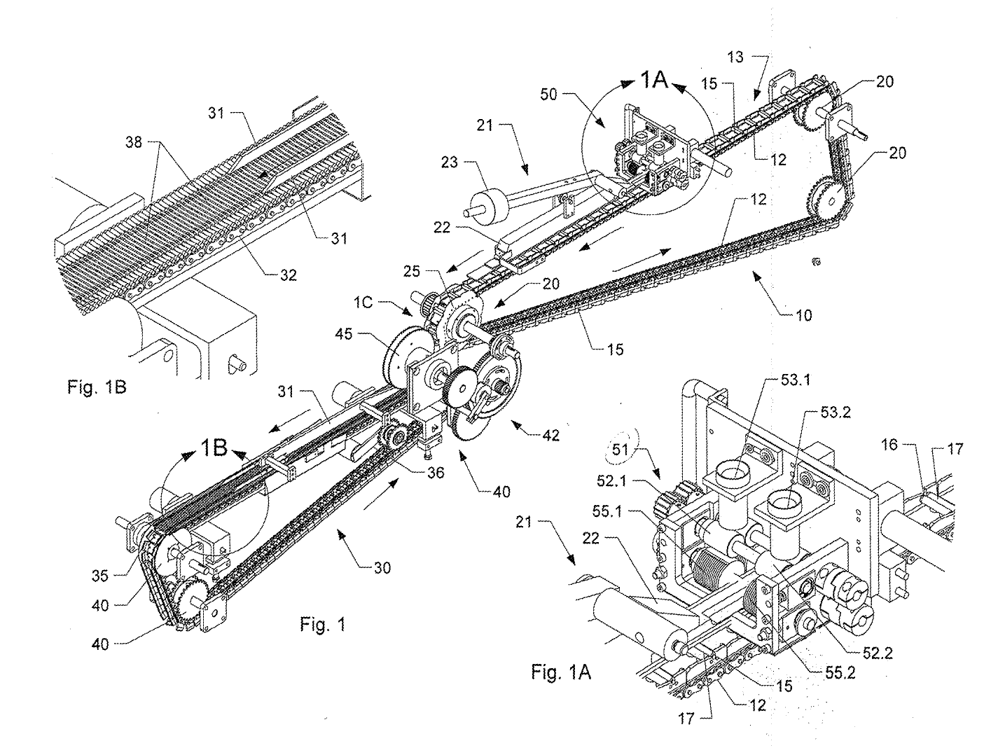

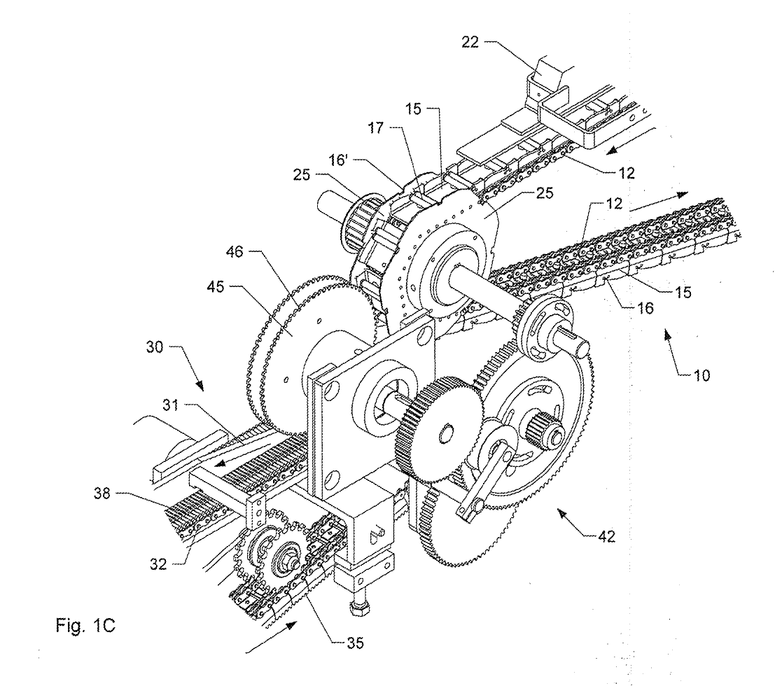

FIG. 1 shows intermeshing subsections of a production plant for producing cotton sticks. This contains an apparatus in the form of a feed unit 50 for feeding in a cotton strand, a further apparatus 13 in the form of a feeder for the blanks, i.e. the “empty” sticks (not shown), a feed side 10 in the form of a primary conveying unit 10 for receiving the empty sticks and for applying the cotton to the ends thereof. The plant furthermore contains a transfer unit 1C for transferring the cotton-bearing sticks to a removal side 30 in the form of a secondary conveying unit 30, which discharges the finished cotton sticks 38 for packaging, for example. The body or machine frame, the mounts and any covers for the overall production plant have been omitted here.

In detail, the primary conveying unit 10 contains a primary carrier chain (primary carrier chain) 12 having means 15, in this case carriers, for receiving and conveying the still empty sticks and for conveying the “wound” and finished cotton sticks 38 onward. The primary carrier chain 12 runs around deflection sprockets 20 and initially passes under an apparatus 13 for feeding in the blanks, e.g. a storage cassette (not shown) containing empty sticks or blanks.

The primary carrier chain 12 then leads to an apparatus 50 for feeding in a further raw material, in this case as a feed unit 50 for attaching the cotton to the sticks, and then under a guide mechanism 21 comprising a shaping module 22 as part of a processing unit, the operation of which will be described below.

The direction of running is indicated by arrows and is counterclockwise for an observer. The finished cotton sticks 38 are transferred by means of a transfer wheel 25 to a carrier wheel 45 (both are parts of the transfer unit 1C) in engagement with the secondary carrier chain (secondary carrier chain) 32 and, from there, are laid on the carriers 35 of the secondary carrier chain 32. For its part, the secondary carrier chain runs around deflection sprockets 40, and the direction of running is likewise indicated by arrows in the counterclockwise direction. Reference sign 36 denotes a chain tensioner. This is a general overview, which will be discussed in detail below.

FIGS. 1A, 1B and 1C show details of the two conveying units 10 and 30 and of the transfer unit 1C. FIG. 1A shows a detail in which can be seen the feed unit 50 for the cotton strand, by means of which unit the cotton fed in is wound onto the sticks, which rotate about their axis during operation.

FIG. 1B shows a detail in which the secondary carrier chain 32 comprising the carriers 35 for the cotton sticks 38 can be seen, the carriers being covered by the cotton sticks. The cotton sticks lie close together and the direction of running is indicated by an arrow. The secondary carrier chain 32 is furthermore assigned hold-down elements 31, which prevent the cotton sticks 38 from jumping out of their holders.

Finally, the detail in FIG. 1C shows the transfer unit 1C with the transfer point comprising the transfer wheel 25, on which it is possible to see the notches 16′ for supporting the cotton sticks, and the carrier wheel 45 which interacts therewith and has the recesses 46 for receiving the transferred cotton sticks. Also visible is the transmission 42 for driving the two carrier chains, the transfer wheel 25 and the carrier wheel 45. The manner in which the transfer point operates will be discussed below with reference to figures shown later.

The feed unit 50 for feeding the cotton to the sticks in accordance with FIG. 1A contains a pair of grommet-shaped guides 53.1 and 53.2, there being one such guide for each end of the cotton stick. The cotton strands inserted therein are fed to respective pinch roller pairs 52.1 and 52.2, which, on the one hand, pull off the two cotton strands and, on the other hand, feed them to respective combing roller pairs 55.1 and 55.2. The rotational speed of the combing roller pairs 55.1, 55.2 is set so that it pulls off or tears off the selected portion of the cotton fed in by the pinch roller pairs 52.1, 52.2. The pinch and combing roller pairs are driven by means of a corresponding transmission 51.

Instead of tearing off, it is also possible for the combing roller pairs 55.1, 55.2 merely to form predetermined tearing points on the cotton strand, dividing the cotton strand into portions. The cotton strand is then torn off at the predetermined tearing point by the stick, which is guided past and takes along the portion of the cotton strand. The predetermined tearing point can be a local thinning of the cotton strand by excess tensile stress, for example.

The sticks fed in, to which rotation has been imparted, are prepared at both ends in such a way that the cotton bud or portion torn off can catch thereon and is thus wound on. The now roughly wound cotton stick is fed in a continuously rotating manner to the holder 22 for the rubber retarding belt in the guide mechanism 21 and is shaped therein. The shaping module (not shown) in the guide mechanism is divided over the length thereof into two channel-shaped molds and is pressed together over the guide mechanism by a weight 23, which can be set by means of a lever. The body of the stick, which lies between the two cotton-bearing ends, as shown at the beginning of the feed unit 50 for the cotton strand, is mounted rotatably on a roller pair 17. The roller pair is part of the carrier 15.

Along the run of the primary carrier chain 12, the body of the stick is braked by a pressed-on rubber belt (not shown), for example, in such a way that the ends of the stick rotate continuously with the cotton over the entire distance and can be molded snugly into the desired shape under the pressure of the channel-shaped mold.

If the two cotton strands have to be fed in at high speed, there may be disruptions at this point too. This can be counteracted by providing a second arrangement of a feed unit 50 with pairs of guides, pinch rollers and combing rollers in the direction of running of the sticks and thus providing only every second of the blanks fed in with cotton in alternation. This method of multiplying the material fed in on the feed side (primary carrier chain) while simultaneously reducing the process speed on the feed side relative to the removal side (secondary carrier chain) can also be employed for feeding in the sticks (blanks), as explained below. This measure leads to higher process reliability and hence to better controllability of the process at the given high production speeds.

The possibility of alternate infeed on the primary side for cotton and also for sticks offers a further advantage. If a fault occurs during infeed to one of the two (or more) feed units, this can be temporarily switched off, while the other module or partner module can be made to run at double speed in order to enable the primary carrier chain to continue running at the same speed, the fault can be eliminated and the feed unit can be reconnected and the two feed units can therefore once again be operated at the original speed. In this way, many of the faults which occur during the running of the production plant can be eliminated, whereas previously it had to be switched off, entailing a loss of production. Infeed from the cassette, also referred to as the stick magazine, with the blanks (not shown) can likewise be duplicated in order to exploit this possibility in the case of the feeding in of the blanks too. Of course, it is also possible to provide more than two feed systems for the cotton and the blanks.

FIG. 1C shows the transfer unit 1C with the transfer point from the primary to the secondary carrier chain. The arrangement density on the carriers of the two carrier chains should be noted. While, in the example shown here, the carriers 15 of the primary carrier chain 12 each convey one cotton stick 38, there are four on one carrier of the secondary carrier chain 32, i.e. at least four times more, this entailing that the two carrier chains run at different speeds. Thus the primary carrier chain 12 runs four times faster than the secondary carrier chain 32. At maximum output, the stress on said chain is very high. If the primary carrier chain 12 were made to run half as fast, for example, in order to reduce the stress, only two sticks would be deposited on the secondary carrier chain 32 for each carrier 35, and gaps would form. If two sticks were fed in instead of one stick by means of the primary carrier chain 12 running at half speed, no gaps would form and the output would be the same as for the high speed of the primary carrier chain 12. This is an effective way of relieving the stress on the primary side without reducing output. The reference signs are the same as those used in the other figures.

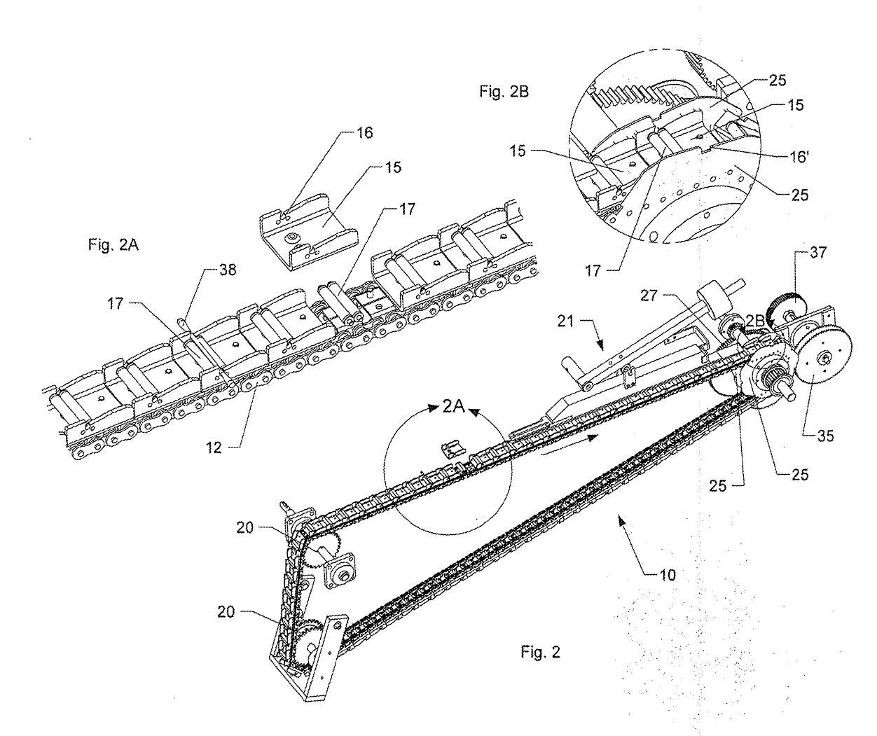

FIG. 2 now shows the primary conveying unit 10 without the feed unit 50 for the cotton in greater detail. The transfer unit with the transfer point from one conveying unit to the other is more easily seen. It is likewise possible to see in greater detail the carrier chain 12 with the carriers 15. A transmission with transmission gearwheels 27, 37, by means of which inter alia the wheels on the transfer unit are driven, is furthermore also shown.

FIG. 2A shows the primary carrier chain 12 with the carriers 15, of which one is raised above the carrier chain. On another carrier 15, a cotton stick 38 can be seen, resting on the rollers of the roller pair 17 and being held in the notch 16. This stick is guided under a guide (not shown here) and braked, as a result of which it begins to rotate on the rollers 17 in order to roll up the cotton. The stick shown here has already passed through the entire production procedure.

FIG. 2B once again shows the transfer point with the transfer wheel 25, which has notches 16′ corresponding to the notches 16 on the carrier 15 in order to be able to receive the cotton sticks and transfer them to the carrier wheel 45. This takes place at the above mentioned high speed.

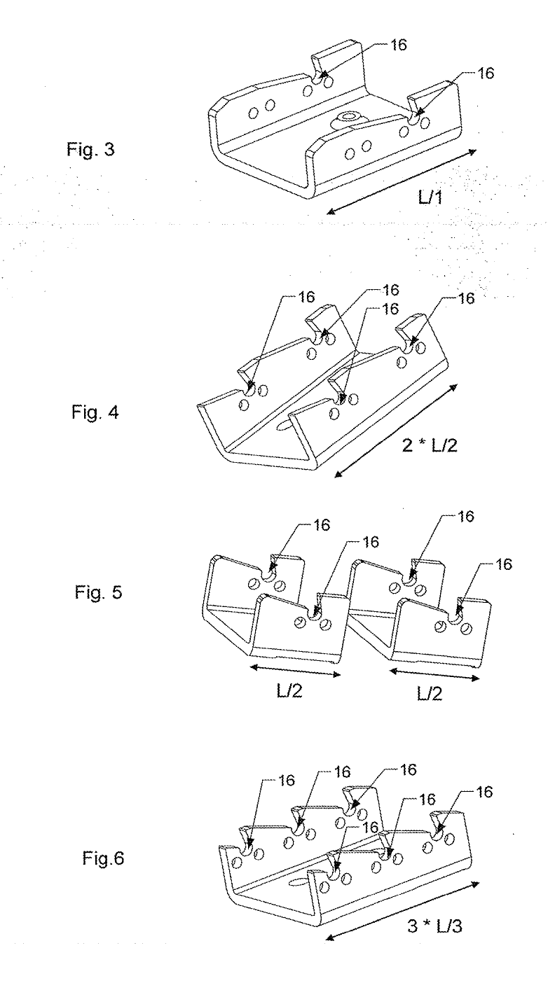

FIGS. 3 to 6 then show carriers 15 of different designs which are used on the primary conveying unit 10. FIG. 3 depicts a currently conventional carrier with the standard length dimension of 2 inches for receiving a cotton stick to be transported. In general, any dimension (of a transport unit) used in the prior art can be denoted in neutral terms by the length L.

FIG. 4 shows a carrier of length L=2 inches with notches 16 for two cotton sticks.

FIG. 5 shows two carriers of length L/2 for receiving a cotton stick and FIG. 6 shows a carrier with 3 pairs of notches 16 for receiving 3 cotton sticks over the length L=2 inches of the carrier shown in FIG. 3, giving a length L/3 per cotton stick, and a length L/2 per cotton stick in the case of FIGS. 4 and 5. Without having to now modify the carrier chain 12 of the conveying unit 10 fundamentally, twice to three times as many sticks can be transported per standard dimensional unit, while maintaining the same speed. Instead of moving away from the standard dimensional unit in the design of the plant, it is possible to transport and thus also produce several times as many cotton sticks with an existing plant within the standard dimension and at the same speed.

However, it is not possible arbitrarily to reduce the distance between two sticks to be provided with cotton, as on the carriers of the secondary carrier chain of the secondary transport unit, for example. The minimum distance L/n (min) must not go below the necessary winding clearance for the cotton head. Based on the standard dimension L=1 inch, this distance should be between L/3 and L/4, wherein only integral denominators can be used. However, even increased to a threefold production capacity at the same speed is a significant result.

If the weight of a carrier, currently composed of metal, is also taken into account, it is thus possible, apart from halving the length L/2, for example, also to reduce the specific weight per transported stick by using plastic. A carrier with L=1 inch made of metal (specific weight=6), weighs 60 grams per transported stick, for example. When halved to L/2 and made of plastic (specific weight=2), the stick would be transported with a carrier weight of 10 grams. A transported weight reduced by a factor of 6 is a quite significant improvement in the case of a machine running at high speed round the clock.

As already mentioned above, another aspect of the invention furthermore relates to reducing the speed of infeed of the cotton strand or cotton sliver since the latter tears very easily during the production process in the current configuration. On the one hand, this can be achieved by increasing the weight of the cotton strand per unit of length, e.g. from 1.4 g/m to 2.8 g/m. In this way, it is possible to feed in the same mass at half the speed. On the other hand, the number of cotton strands fed in can be doubled or multiplied from the current 2 to 4, 6 and 8 etc. As a result, each pair of cotton strands passes the cotton only to every second stick. This measure likewise halves the speed of the cotton strand.

According to a special development of the present invention, the sliver weight of a cotton sliver fed in is reduced in a drafting system, in particular a roller drafting system, to a setpoint sliver weight required for processing by exerting a draft before it is fed to the feed unit for the cotton sliver.

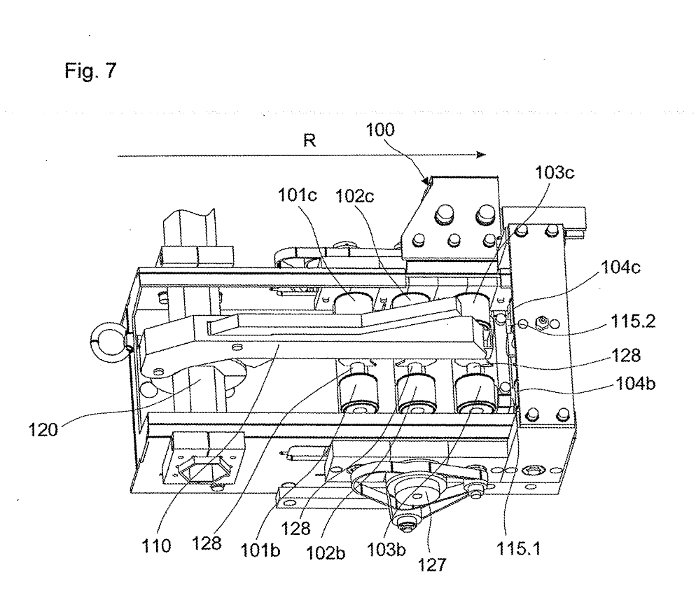

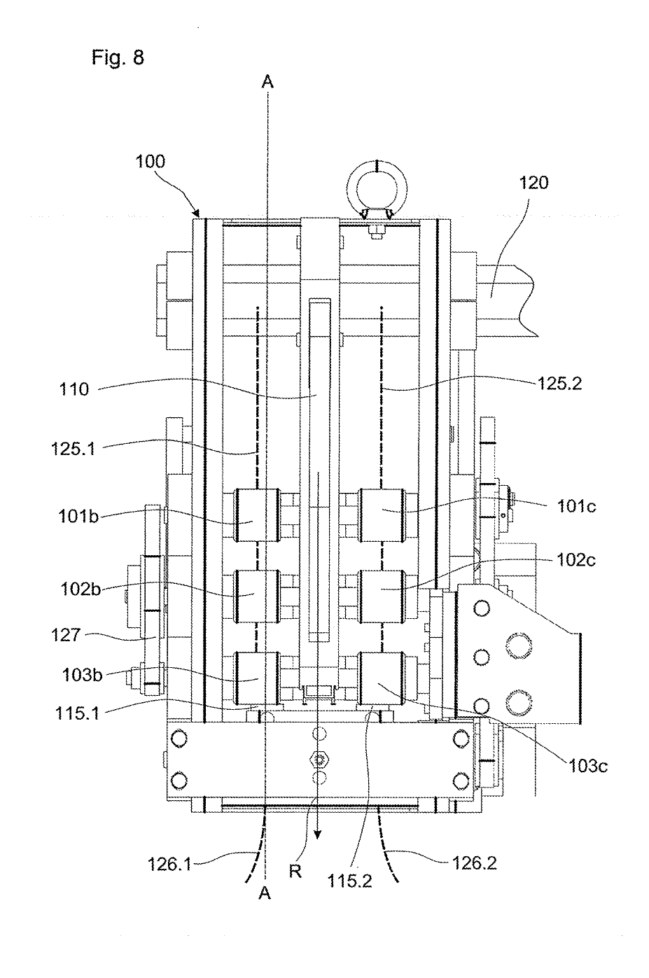

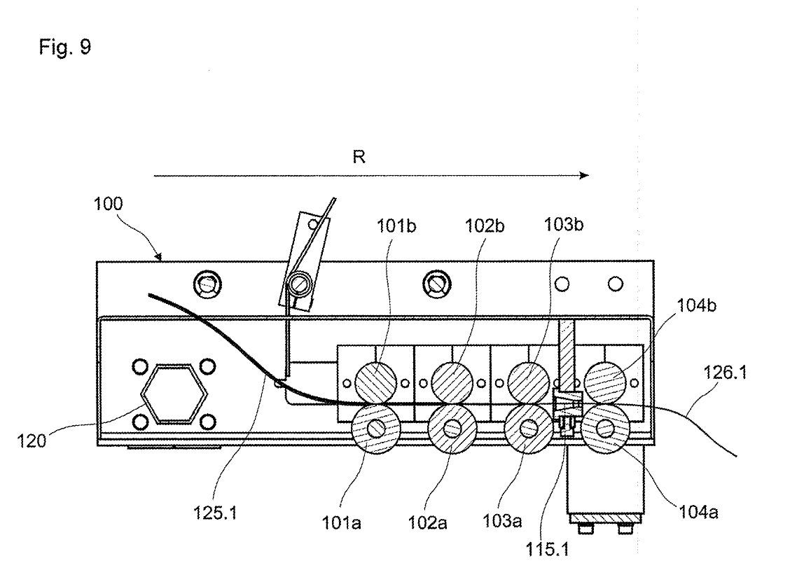

FIGS. 7 to 9 now show a roller drafting system 100 preferably used in the production plant according to the invention for drafting a cotton sliver 125.1, 125.2, in particular a card sliver.

The roller drafting system comprises a total of four bottom rollers 101a, 102a, 103a, 104a arranged one behind the other in process direction R and spaced apart. The roller drafting system 100 is designed for processing two cotton slivers 125.1, 125.2 guided next to one another substantially in parallel and spaced apart in process direction R. For this purpose, the bottom rollers 101a, 102a, 103a, 104a extend over both processing locations. The bottom rollers are manufactured from steel, for example.

The bottom rollers 101a, 102a, 103a, 104a are each assigned top rollers 101b, 101c; 102b, 102c; 103b, 103c; 104b, 104c. For each bottom roller 101a, 102a, 103a, 104a, each working location is assigned a separate top roller 101b, 101c; 102b, 102c; 103b, 103c; 104b, 104c. That is to say, each bottom roller 101a, 102a, 103a, 104a is assigned two top rollers 101b, 101c; 102b, 102c; 103b, 103c; 104b, 104c spaced apart and adjacent to one another when viewed in process direction R. The top rollers preferably have a working surface made from a rubber-elastic material.

Each pair of top and bottom rollers forms a nip, through which the cotton sliver 125.1, 125.2 is passed.

The two processing locations of the roller drafting system 100 now comprise a first roller pair 101a, 101b; 101a, 101c with a top entry roller 101b, 101c and a bottom entry roller 101a, in each case when viewed in process direction R. The rotating entry roller pair 101a, 101b; 101a, 101c pulls the cotton sliver 125.1, 125.2 fed in from the outside into the drafting system 100.

Spaced apart from the first roller pair 101a, 101b; 101a, 101c in process direction R, there follows a second roller pair 102a, 102b; 102a, 102c with a top drafting roller 102b, 102c and a bottom drafting roller 102a. A drafting zone is then formed between the first and second roller pairs, in which zone the cotton sliver 125.1, 125.2 is subjected to a first draft, referred to as the preliminary draft. For this purpose, the rollers of the second roller pair 102a, 102b; 102a, 102c rotate at a higher peripheral speed than the rollers of the first roller pair 101a, 101b; 101a, 101c, with the result that the fibers nipped by the nip of the second roller pair 102a, 102b; 102a, 102c are pulled out of the composite fiber structure by a certain amount in process direction R, with the cotton sliver 125.1, 125.2 becoming thinner.

The second roller pair 102a, 102b; 102a, 102c is followed in process direction R by a third roller pair 103a, 103b; 103a, 103c, which is spaced apart from the second roller pair 102a, 102b; 102a, 102c. A second drafting zone, referred to as the main drafting zone, is formed between the first and second roller pairs. In the main drafting zone, the cotton sliver 125.1, 125.2 emerging from the nip of the second roller pair 102a, 102b; 102a, 102c is subjected to a further draft.

Here too, the draft arises from the fact that the rollers of the third roller pair 103a, 103b; 103a, 103c rotate at a higher peripheral speed than the rollers of the second roller pair 102a, 102b; 102a, 102c, with the result that the fibers nipped by the nip of the third roller pair 103a, 103b; 103a, 103c are pulled out of the composite fiber structure by a certain amount in process direction R, with the cotton sliver 125.1, 125.2 becoming thinner.

The main draft of the sliver preferably takes place in the main drafting zone while only a slight preliminary draft is preferably performed in the preliminary drafting zone, serving, in particular, to loosen the composite fiber structure in the cotton sliver. The preliminary draft and the main draft give the total draft of the cotton sliver.

The third roller pair 103a, 103b; 103a, 103c is followed in process direction R by a fourth roller pair 104a, 104b; 104a, 104c, which is likewise spaced apart from the third roller pair 103a, 103b; 103a, 103c in process direction R. The fourth roller pair 104a, 104b; 104a, 104c comprises a top delivery roller 104b, 104c and a bottom delivery roller 104a. A compressor element 115.1, 115.2, here in the form of a funnel which tapers in process direction R, is in each case arranged between the third and fourth roller pairs. The compressor element 115.1, 115.2 serves to compress the composite fiber structure of the cotton sliver 125.1, 125.2, which has been loosened by the drafting operation. The cotton sliver 125.1, 125.2, which has now been drafted into a thinner cotton strand 126.1, 126.2, is discharged from the drafting system 100 by the rotating rollers of the delivery roller pair 104a, 104b; 104a, 104c. The cotton strand 126.1, 126.2 is then fed to the feed unit 50, by means of which the cotton is applied to the sticks.

The drafting system 100 also contains driving means in the form of a transmission 127 for driving the bottom drafting system rollers 101a, 102a, 103a, 104a. The top rollers 101b, 101c; 102b, 102c; 103b, 103c; 104b, 104c, in contrast, are driven merely passively by the bottom rollers 101a, 102a, 103a, 104a. To form a nip and reduce torque of the bottom rollers, the top rollers 101b, 101c; 102b, 102c; 103b, 103c; 104b, 104c are each pressed onto the corresponding bottom rollers 101a, 102a, 103a, 104a by exerting a pressing pressure.

For this purpose, the top rollers 101b, 101c; 102b, 102c; 103b, 103c; 104b, 104c are mounted on a load imposition arm 110, by means of which they are pressed onto the bottom rollers 101a, 102a, 103a, 104a. The two top rollers 101b, 101c; 102b, 102c; 103b, 103c; 104b, 104c of two roller pairs guided in parallel are each connected to one another by an axle 128 and are spaced apart. The top rollers 101b, 101c; 102b, 102c; 103b, 103c; 104b, 104c are rotatably mounted on said axle 128.

The load imposition arm 110 then reaches between the top roller pairs 101b, 101c; 102b, 102c; 103b, 103c; 104b, 104c and holds them by means of the axle 128 thereof. The load imposition arm 110 can be pressurized by means of a pneumatic pressurization device 120. The imposition of pressure can also be accomplished by a mechanical spring.

The load imposition arm 110 can furthermore be opened. For this purpose, the load imposition arm 110 is raised by means of a handle, thereby lifting the top rollers off the bottom rollers.

The drafting of the cotton sliver 125.1, 125.2 in the drafting system 100 is preferably performed in line in the production process for the cotton sticks. Accordingly, the drafting system 100 and, in particular, the drives thereof are integrated in terms of control engineering and preferably also mechanically into the production plant. The bottom drafting system rollers are then preferably driven by means of a central drive, which also drives other plant components of the production plant, e.g. the primary carrier chain. The driving torque is transmitted to the bottom rollers by an appropriate transmission.

According to a current example, a cotton sliver 125.1, 125.2 in the form of a card sliver with a sliver weight of around 8 g/m is fed to the drafting system 100. In the drafting system 100, the cotton sliver is subjected to a fivefold to sixfold draft. Ideally, the cotton strand 126.1, 126.2 produced from the cotton sliver 125.1, 125.2 then has a weight of around 1.4 to 1.5 g/m.

The use of a drafting system in a production plant according to the invention has the following advantages:
the drafting system ensures a uniform draft, with the result that a cotton strand produced from a cotton sliver in a drafting system has a high degree of uniformity;
owing to its thickness, the card sliver fed into the production plant from a storage container, such as a can, is significantly more resistant to tearing than a thinner cotton strand, and this in turn reduces susceptibility to faults. The conveyer section in which the tear-prone cotton strand is conveyed between the drafting system and the feed unit is considerably shortened by virtue of the integrated drafting system;
by means of the drafting system according to the invention, it is possible to process card slivers of different sliver weights, and all that is necessary to produce cotton strands of the same weight is to adjust the draft parameters in the drafting system in terms of control engineering. This provides great flexibility in the sourcing of cotton slivers from third-party producers; and
the drafting system according to the invention makes it possible to source low-cost but relatively heavy standard card slivers characterized by a standard sliver weight of 8 to 20 g/m.

The production parameters will be discussed below. The parameters comprising the speed of the primary carrier chain V_{K}, the angular speed of the stick V_{Rot} and the speed with which the cotton is fed in V_{W} require special attention in the production process. The following parameters have to be taken into account:

Monitored Parameters

Stick Spacing Sₛ

The distance between the sticks on the primary carrier chain. Currently, this dimension is 2″ (50.8 mm), the new possibility for this dimension being 1″ (25.4 mm).

Machine Output P

Number of sticks produced per minute; current maximum is between 2,700-3,000 sticks/minute.

Rubber Belt Speed v_{G}

The sticks rest on 2 rollers and can therefore be rotated. A stationary rubber belt is positioned on the top side between the roller shaping elements, on which belt the sticks are braked and, as a result, begin to rotate. This rubber belt can also be driven; a positive speed means that the rubber belt is running in the direction of running of the primary carrier chain, while a negative value means that it is running with the opposite chain speed.

If the belt is driven in the same direction of running as the primary carrier chain, this results in a speed of rotation of the stick in the clockwise direction; if the belt runs at a speed greater than the chain speed in the opposite direction to the primary carrier chain, the stick rotates counterclockwise. When the belt has the same direction of running as the primary carrier chain, a positive percentage value is input, while a negative value is input when the belt is running in the opposite direction.

Resulting Parameters:

Chain Speed v_{K}

The chain speed is the product of the stick spacing sₛ and the machine output P.

V_{K}=s_{S}*P

Stick Rotational Speed v_{Rot}

The stick rotational speed is dependent on the stick diameter d, the chain speed v_{K} and the rubber belt speed v_{G}. A positive value means that the sticks are rotating in the “windup direction”, i.e. counterclockwise, while a negative value means that they are rotating in the “counter rollup direction”, i.e. clockwise.

v_{Rot}=v_{K}*(v_{G}−1)*(d*pi)⁻¹

Length of Cotton (Absorbent Cotton) l_{W}

Results directly from the value for heads per meter x_{S} and describes the length of a single piece of cotton sliver before being rolled up. In practice, this value is higher since the cotton is extended in length as it is torn apart.

l_{W}=1/xₛ

Speed of Cotton (Absorbent Cotton) Strand v_{W}

The speed of the cotton strand is made up of the machine output P and the value for heads per meter x_{S}.

v_{W}=P/x_{S}

From the relationships described above, it is immediately apparent that a reduction in v_{K} has a considerable effect on other parameters which determine the wear on the primary carrier chain.

The aim is to considerably reduce some or all the speeds v in the plant, thereby also reducing the wear on the plant and increasing process stability.

Other influencing factors which have not yet been elucidated in the above considerations are forces which act on the primary carrier chain and contribute to the wear thereof. These are frictional forces F_{R}, acceleration forces F_{G}, torques F_{M} and centripetal forces F_{Z}. The force on a single chain link (F_{Total}) is made up of a number of forces. The maximum force is highest just before the driving chain sprocket.

F_{Total}=F_{R}+F_{M}+F_{Z}+F_{G}

F_{Reibung}=Frictional Forces

Frictional forces are inherent in the design. They are caused by chain guides, cleaning brushes and resistances in the region of the roller shaping elements.

F_{M}=Torsional Forces

Torsional forces are inherent in the design. They are caused by the frictional resistances in the chain sprockets.

F_{Z}=Centripetal Forces

Centripetal forces are caused by changes in the direction of the carrier chain on the chain sprockets. The centripetal forces increase
linearly with the increase in mass
as the square of the chain speed
and decrease linearly with the radius

F_{G}=Acceleration Forces

Acceleration forces arise between stoppages and when the machine is running. The faster the setpoint chain speed is reached, the higher are the forces on the carrier chain. The acceleration forces increase
linearly with mass
linearly with acceleration

All the effective forces described above are either speed- or mass-dependent or are speed- and mass-dependent. The lower the weight and speed of the primary carrier chain, the smaller are the effective forces and the smaller is the wear on the components, the better is control of the process, the lower the reject rate and the greater the availability of the plant.

By means of the multiple loading of or shorter distances between the sticks with a simultaneous reduction in speed and mass, it is possible to set a production speed which is optimized for wear, thereby allowing optimum exploitation of the production potential of a plant. Another advantage is the reduced space requirement for the overall plant since the reduction in stick spacing during production makes it possible to achieve a more compact construction.

The production plant for bulk goods comprising a feed side 10 for the raw material (empty cotton sticks) and a processing unit for said raw material and a removal side 30 for the processed products 38 (cotton sticks) comprises, for the production of cotton sticks, means 13 (a stick cassette containing blanks), 15 (special carriers for the blanks), 50 (apparatus for feeding in cotton) for selectively multiplying the infeed of the raw material (sticks and cotton) on the feed side 10, whereby, by correspondingly reducing the feed speed on the feed side 10 in relation to the removal speed of the processed products 38 (cotton sticks), the feed rate or removal rate is increased or reduced and hence the transport speed is reduced while the output of the products 38 on the feed side 10 remains the same, thereby reducing disruptions during processing and wear on the production plant and improving control of the process. The carriers 15 for selectively multiplying the infeed of the raw material (empty sticks) are manufactured either from metal or, preferably, from plastic. The weight on the carrier chain is thereby reduced. To increase the feed rate or removal rate, the carriers 15 can be designed in such a way that a plurality of blanks can be accommodated along the length thereof. The current standard dimension is approximately two inches for one stick. Modifying this to approximately one inch enables twice the number of blanks to be accommodated per unit of length.

On the one hand, there can be several feed modules 13 for feeding the sticks and 50 for feeding the cotton to the feed side 10, and they can be switched selectively so that they can be switched on or off according to requirements. This is the case, for example, when one of them is faulty. The feed modules 50, 13 can be switched in such a way that they load the carriers 15 completely or only partially.

1. A production plant for producing bulk goods, comprising
a feed side for feeding in a raw material;
a processing unit for producing products, by processing the raw material fed in;
and comprising a removal side for removing the products,
wherein
the production plant comprises an apparatus on the feed side for multiplying the infeed of raw material, as a result of which the feed speed of the raw material to the processing unit on the feed side is reduced to give a constant output of products on the removal side.

2. The production plant as claimed in claim 1, wherein the raw material is in the form of blanks, which, while being held on carriers, can be fed to the processing unit by a carrier chain.

3. The production plant as claimed in claim 2, wherein multiplying the infeed of raw material on the feed side is achieved by reducing the spacing of the blanks on the carrier chain.

4. The production plant as claimed in claim 1, wherein the production plant comprises at least one first apparatus for feeding in a first raw material and/or at least one second apparatus for feeding in a second raw material.

5. The production plant as claimed in claim 2, wherein the production plant is provided with a plurality of first and/or second apparatuses for feeding a first and/or second raw material onto the carriers of the circulating carrier chain, which apparatuses selectively feed the raw materials to the feed side in alternation.

6. The production plant as claimed in claim 1, wherein the processing unit of the production plant comprises a device configured to apply the second raw material to ends of the first raw material, said second raw material being adapted to be shaped upon the end of the first raw material.

7. The production plant as claimed in claim 2, wherein the carriers for feeding in the first raw material are manufactured from metal or from plastic.

8. The production plant as claimed in claim 2, wherein, to increase the feed rate or removal rate, the production plant comprises carriers the blanks, and wherein a spacing between adjacent carriers is reduced by half from a standard dimension thereby providing space for twice a number of blanks per unit of length.

9. The production plant as claimed in claim 2, wherein, to increase the feed rate or removal rate, the production plant comprises carriers having a plurality of holding receptacles along the length of which there is space for a plurality of blanks.

10. The production plant as claimed in claim 5, further comprising first and/or second apparatuses on the feed side, which can be selectively switched.

11. The production plant as claimed in claim 10, wherein the first and/or second apparatuses load the carriers fully or partially.

12. The production plant as claimed in claim 1, wherein the production plant has a drafting system, in which a sliver fed in is subjected to a draft while reducing a weight of the sliver.

13. The production plant as claimed in claim 12, wherein the drafting system is a roller drafting system, having at least two rotating roller pairs, which are spaced apart and can be rotated at different peripheral speeds.

14. A method for controlling a production plant as claimed in claim 1, wherein the infeed of raw material is multiplied, and thus the raw material is fed in to the processing unit at a reduced feed speed on the feed side to give a constant output of products.

15. The method as claimed in claim 14, wherein a wear-optimized production speed can be set by reducing the mass of the feed per blank.

16. The method as claimed in claim 14, further comprising the following steps:
feeding in a cotton sliver to the drafting system of the production plant;
creating a draft in the cotton sliver by pulling the fibers in the sliver apart, reducing the sliver weight;
feeding the drafted cotton sliver to the feed unit of the production plant;
dividing up the fed and drafted cotton sliver and loading the sticks with cotton.

17. The method as claimed in claim 15, further comprising the following steps:
feeding in a cotton sliver to the drafting system of the production plant;
creating a draft in the cotton sliver by pulling the fibers in the sliver apart, reducing the sliver weight;
feeding the drafted cotton sliver to the feed unit of the production plant;
dividing up the fed and drafted cotton sliver and loading the sticks with cotton.
